(19) United States
(12) Patent Application Publication
(10) Pub. No.: US 2011/0187299 A1
(43) Pub. Date: Aug. 4, 2011

(54) FAN SYSTEM AND BRAKING CIRCUIT THEREOF

(76) Inventors: Alex HORNG, Kaohsiung (TW); Kuan-Yin HOU, Kaohsiung (TW); Chung-Ken CHENG, Kaohsiung (TW); Shou-Chien CHANG, Kaosiung (TW); Chia-Chin WU, Kaohsiung (TW)

(21) Appl. No.: 12/697,535

(22) Filed: Feb. 1, 2010

(51) Int. Cl. H02P 3/10

(52) U.S. Cl. 318/368

(57) ABSTRACT

A fan system comprising a motor, a motor driving circuit and a control unit is disclosed. The motor driving circuit is coupled to the motor. The control unit is coupled to the motor driving circuit, generates a forward rotation command for controlling the motor to rotate in a predetermined direction when the control unit receives electrical power, and generates a backward rotation command for controlling the motor to rotate in a direction opposite to the predetermined direction when the control unit fails to receive the electrical power.

### BACKGROUND OF THE INVENTION

1. Field of the Invention

The present invention generally relates to a fan system and a braking circuit thereof, more particularly, to a fan system and a braking circuit thereof that utilize a control unit to generate a backward rotation command for performing a braking operation of the fan system.

2. Description of the Related Art

In recent years, the micro controller unit (MCU) and the power electronic switch driving circuit have been combined to design electronic products. During the operation of the electronic products, however, a significant amount of heat is generated due to the high frequency operation of the MCU and the power electronic switch driving circuit. Therefore, the heat dissipation of the electronic products has become an important issue.

Currently, fan systems are widely adopted for heat dissipation of electronic products. In consideration of the control and safety issues, the fan systems are often combined with a stopping circuit to stop the operation thereof when the fan systems are powered off. Thus, the controlling of the fan systems and the user safety are ensured.

As shown in FIG. 1, a traditional fan system and a braking circuit thereof are disclosed. The traditional fan system and the braking circuit thereof comprise a bridge driver 91, a control unit 92, a storage capacitor 93, an immediate stopping unit 94 and a motor coil 95. A power supply Vcc is connected to the bridge driver 91, control unit 92, storage capacitor 93 and immediate stopping unit 94 for providing the power required. The bridge driver 91 comprises two upper bridge electronic switches M91 and M94, as well as two lower bridge electronic switches M92 and M93. The immediate stopping unit 94 comprises two electronic switches M95 and M96 connected to the lower bridge electronic switches M93 and M92, respectively. The control unit 92 comprises four control ends respectively connected to the electronic switches M95 and M96 of the immediate stopping unit 94 and two additional electronic switches M97 and M98. One end of the motor coil 95 is connected to a node where the upper bridge electronic switch M91 and the lower bridge electronic switch M93 are connected, and another end of the motor coil 95 is connected to a node where the upper bridge electronic switch M94 and the lower bridge electronic switch M92 are connected.

When the power supply Vcc is provided to the fan system as normal, the control unit 92 generates a set of control signals on the control ends thereof to start the operation of the bridge driver 91 and the immediate stopping unit 94. As such, the upper bridge electronic switches (M91 and M94) and the lower bridge electronic switches (M92 and M93) are turned on in turn so that a commutation current is generated on the motor coil 95. For instance, the upper bridge electronic switch M91 and the lower bridge electronic switch M92 are turned on while the upper bridge electronic switch M94 and the lower bridge electronic switch M93 are turned off, such that the commutation current flows through the motor coil 95 in a forward direction. On the contrary, the upper bridge electronic switch M94 and the lower bridge electronic switch M93 are turned on while the upper bridge electronic switch M91 and the lower bridge electronic switch M92 are turned off, such that the commutation current flows through the motor coil 95 in a backward direction. The storage capacitor 93 may be charged until a certain power level is attained.

When the power supply Vcc is terminated, the control unit 92 no longer generates the control signals for the bridge driver 91 and the immediate stopping unit 94. As a result, the electronic switches M95 and M96 of the immediate stopping unit 94 are turned off and the storage capacitor 93 is discharged. In the meanwhile, since the input ends of the lower bridge electronic switches M92 and M93 (such as the gates shown in FIG. 1) are coupled to the storage capacitor 93, the lower bridge electronic switches M92 and M93 may be turned on due to the discharging of the storage capacitor 93. As a result, the two ends of the motor coil 95 remain the same potential and the operation of the fan system is therefore stopped.

In general, the traditional fan system described above has some drawbacks. For example, the immediate stopping unit 94 is required for immediately stopping the operation of the fan system in the moment the fan system is powered off, which increases the circuitry routing complexity of the fan system. In addition, the control mechanism of the fan system becomes more complex and the cost is also increased. Therefore, there is a need to improve the above fan system and the braking circuit thereof.

### SUMMARY OF THE INVENTION

It is the primary objective of the invention to overcome the drawbacks of the above fan system and the braking circuit thereof When a power supply of the fan system is terminated, the invention performs a braking operation of a motor of the fan system via a backward rotation command generated by a control unit, thereby simplifying the controlling and the circuitry of the braking circuit.

It is the secondary objective of the invention to provide a fan system and a braking circuit thereof in which a braking operation of the fan system is performed by a control unit, thereby reducing the cost of the fan system.

The invention discloses a fan system comprising a motor, a motor driving circuit and a control unit. The motor driving circuit is coupled to the motor. The control unit is coupled to the motor driving circuit, generates a forward rotation command for controlling the motor to rotate in a predetermined direction when the control unit receives electrical power, and generates a backward rotation command for controlling the motor to rotate in a direction opposite to the predetermined direction when the control unit fails to receive the electrical power.

The invention further discloses a braking circuit of a fan system. The braking circuit of the fan system comprises a control unit which generates a forward rotation command for controlling a motor to rotate in a predetermined direction when the control unit receives electrical power, and generates a backward rotation command for controlling the motor to rotate in a direction opposite to the predetermined direction when the control unit fails to receive the electrical power.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a circuit diagram of a traditional fan system and a braking circuit thereof;

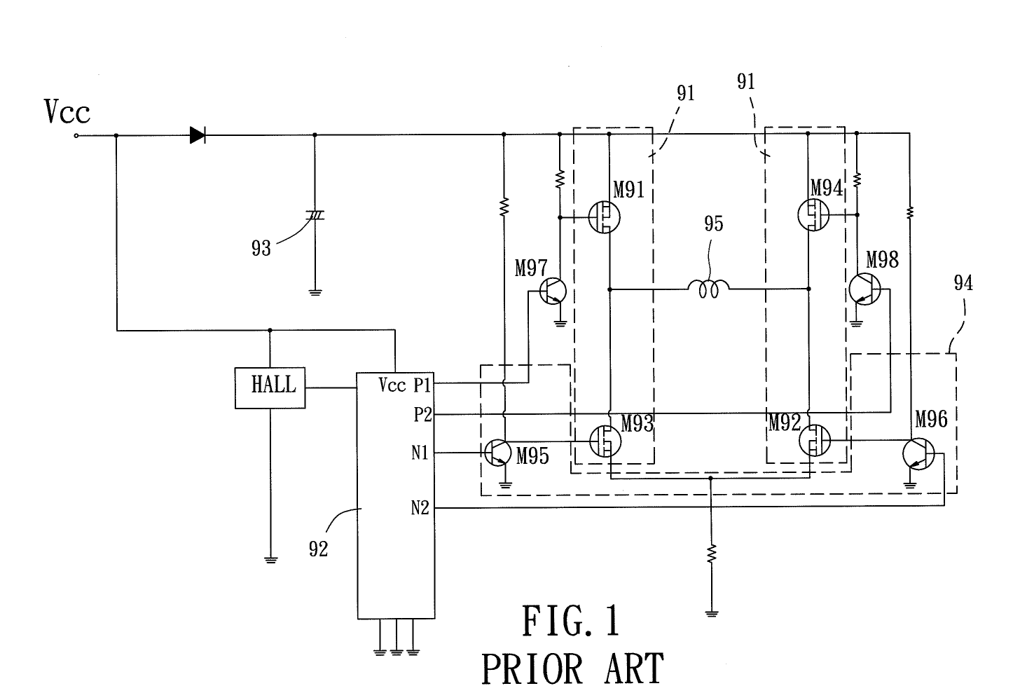

FIG. 2 shows a circuit diagram of a fan system and a braking circuit thereof according to a preferred embodiment of the invention;

FIG. 3 shows a diagram illustrating an application where the proposed fan system and the braking circuit thereof are used in a three-phase motor according to the preferred embodiment of the invention;

FIG. 4 shows a diagram illustrating a relation of desired coil currents versus time of the motor shown in FIG. 3, according to the preferred embodiment of the invention;

FIG. 5 shows a diagram illustrating an application where the proposed fan system and the braking circuit thereof are used in a single-phase motor according to the preferred embodiment of the invention; and

FIG. 6 shows a diagram illustrating a relation of desired coil currents versus time of the motor shown in FIG. 5, according to the preferred embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

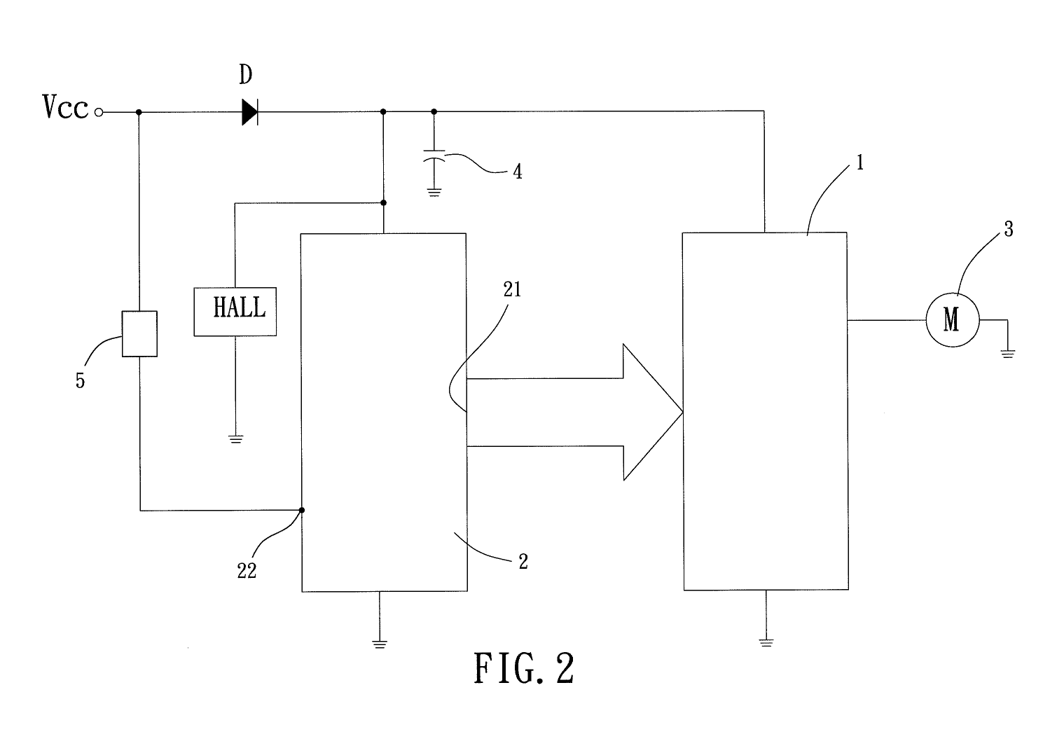

Please refer to FIG. 2, a fan system and a braking circuit thereof are disclosed according to a preferred embodiment of the invention. The fan system comprises a motor driving circuit 1, a control unit 2, a motor 3 and a storage unit 4. A power supply Vcc is electrically connected to the motor driving circuit 1, control unit 2 and storage unit 4 via a diode D. In other words, the motor driving circuit 1, control unit 2 and storage unit 4 are electrically connected to a cathode of the diode D while the power supply Vcc is connected to an anode of the diode D, so that the motor driving circuit 1, control unit 2 and storage unit 4 may be supplied by the power supply Vcc via the diode D.

The motor driving circuit 1 comprises a plurality of electronic switches. The motor driving circuit 1 is preferably a full-bridge or half-bridge driving circuit and is electrically connected to the motor 3 to form a full-bridge or half-bridge structure. The number of the electronic switches of the motor driving circuit 1 is dependent on the phase number of the motor 3. Each electronic switch has an input end for receiving an ON/OFF signal. The control unit 2 may be a micro controller or motor driving integrated circuit (IC) and comprises a control port 21 having a plurality of control ends. The control ends of the control port 21 are electrically connected to the electronic switches of the motor driving circuit 1, respectively. Accordingly, the control unit 2 may output a set of forward rotation control signals or backward rotation control signals, with the set of forward rotation control signals altogether forming a forward rotation command and the set of backward rotation control signals altogether forming a backward rotation command, so as to control the switching operation of the electronic switches of the motor driving circuit 1 for triggering a forward/backward rotation of the motor 3.

In addition, the control unit 2 further comprises a voltage detection end 22. The voltage detection end 22 is electrically connected to the power supply Vcc to determine whether an abnormality of the power supply Vcc has occurred. To ensure a proper voltage to be received at the voltage detection end 22 of the control unit 2, the voltage detection end 22 may be electrically connected to the anode of the diode D via a voltage conversion unit 5 and receive the power supply Vcc via the voltage conversion unit 5. The voltage conversion unit 5 may be of a voltage-dividing network in which the proper voltage suitable for operating the control unit 2 is outputted by the voltage-dividing network (for example, a 12V power supply Vcc is divided into a 3V voltage signal sent to the control unit 2). In this way, the control unit 2 may be protected from the higher voltage. Moreover, under the arrangement where the voltage detection end 22 is electrically connected to the anode of the diode D and the storage unit 4 is electrically connected to the cathode of the diode D, the voltage conversion unit 5 may be protected from being impacted by the discharged voltage of the storage unit 4 via the diode D, thereby ensuring the performance of the voltage conversion unit 5.

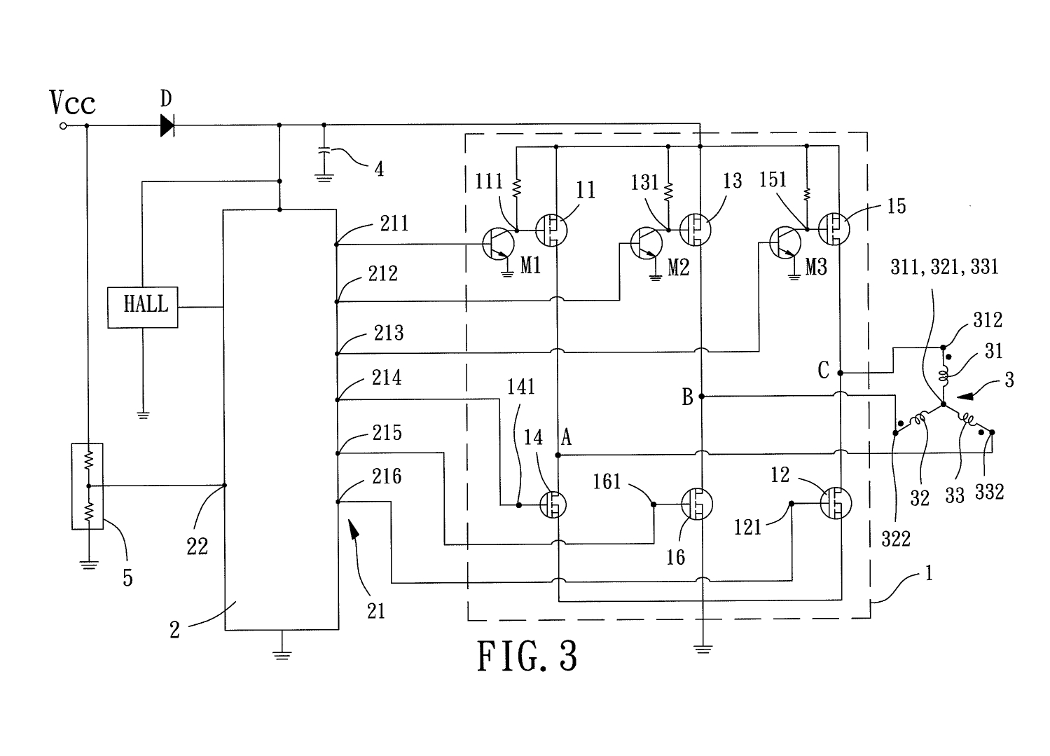

Please refer to FIG. 3, the motor 3 of the preferred embodiment of the invention is disclosed as a three-phase motor, such as a three-phase brushless direct current (DC) motor. To comply with the phase number of the motor 3, three bridge-arms are arranged in the motor driving circuit 1. The first bridge-arm consists of two series electronic switches 11 and 14 and has a first connection node A. The second bridge-arm consists of two series electronic switches 13 and 16 and has a second connection node B. The third bridge-arm consists of two series electronic switches 15 and 12 and has a third connection node C. The electronic switches 11 to 16 are implemented by MOS transistors and have six input ends respectively numbered as 111, 121, 131, 141, 151 and 161. The input ends 111 to 161 may receive the forward/backward rotation command so that the corresponding electronic switch is turned-on or turned-off. The input ends 111, 131 and 151 of the upper bridge electronic switches 11, 13 and 15 are connected to the transistor switches M1, M2 and M3, respectively. With the transistor switches M1, M2 and M3, the switching operation of the upper bridge electronic switches 11, 13 and 15 may be controlled.

Please refer to FIG. 3 again, to comply with the phase number of the motor 3, the control port 21 may comprise six control ends 211, 212, 213, 214, 215 and 216 connected to the electronic switches 11 to 16, respectively. The control unit 2 generates the forward/backward rotation control signals and sends the forward/backward rotation control signals to the electronic switches 11 to 16 via the control ends 211 to 216 for controlling the switching operation of the electronic switches 11 to 16.

Please refer to FIG. 3 again, the three-phase motor 3 comprises three coils 31, 32 and 33. The first coil 31 has a first output end 311 and a first input end 312. The second coil 32 has a second output end 321 and a second input end 322. The third coil 33 has a third output end 331 and a third input end 332. The output ends 311, 321 and 331 of the coils 31, 32 and 33 are connected together so that the motor 3 appears to be a Y-shaped connection. The first input end 312 of the first coil 31 is connected to the third connection node C of the third bridge-arm. The second input end 322 of the second coil 32 is connected to the second connection node B of the second bridge-arm. The third input end 332 of the third coil 33 is connected to the first connection node A of the first bridge-arm.

When the proposed fan system is normally supplied with electrical power by the power supply Vcc and a proper voltage (e.g. 3V) converted by the voltage conversion unit 5 is detected by the control unit 2 via the voltage detection end 22, the control unit 2 generates the forward rotation command which is further sent to the electronic switches 11 to 16. With the switching operation of the electronic switches 11 to 16, the current direction on the coils 31, 32 and 33 can be controlled. Based on this, the motor 3 may rotate in a predetermined direction (e.g. in a clockwise direction) via the controlling of the forward rotation command. In the same time, the storage unit 4 is constantly supplied by the power supply Vcc and may store a certain level of electrical power.

However, when an abnormality of the power supply Vcc is occurred due to a voltage dropping, an improper voltage lower than an operable threshold voltage value (e.g. 2.4V) of the control unit 2 would be detected by the control unit 2 via the voltage detection end 22. In this case, since the storage unit 4 is connected to the control unit 2, the operation of the control unit 2 is maintained due to the discharging of the storage unit 4. At this moment, the control unit 2 generates the backward rotation command for the electronic switches 11 to 16, driving the motor 3 to rotate in a direction opposite to the predetermined direction (e.g. in a counterclockwise direction). As a result, the motor 3 of the fan system is quickly stopped.

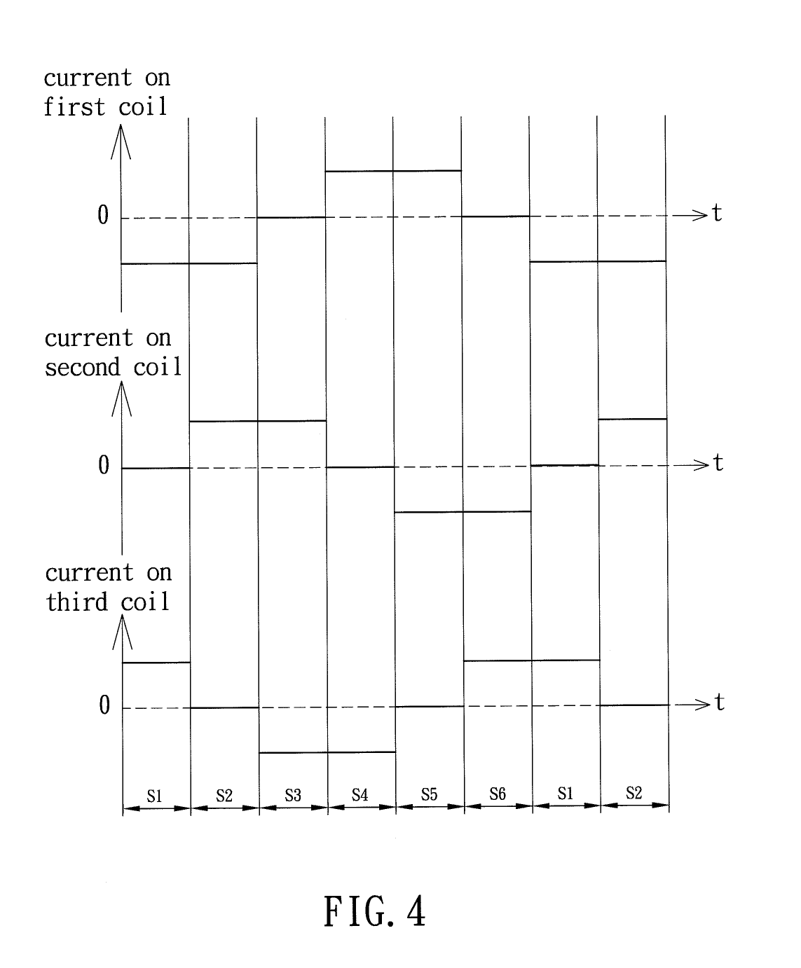

The invention herein constructs the forward and backward rotation commands using a periodic signal having a plurality of time intervals, as the periodic signal with six time intervals S1 to S6 shown in FIG. 4. The time intervals S1 to S6 may be repeatedly operated in a forward sequence, such as S1, S2, S3, S4, S5, S6, S1 . . . etc., allowing the control ends 211 to 216 of the control unit 2 to output the forward rotation command. Alternatively, the time intervals S1 to S6 may be repeatedly operated in a backward sequence, such as S6, S5, S4, S3, S2, S1, S6 . . . etc., allowing the control ends 211 to 216 of the control unit 2 to output the backward rotation command. Following, the invention will discuss the details of the braking operation of the motor 3 that is performed using the forward and backward rotation commands.

Please refer to FIGS. 3 and 4, a diagram illustrating the change of the currents on the coils 31, 32 and 33 of the motor 3 in term of the six time intervals S1 to S6 is shown. During the operation of the time interval S1, as controlled by the control unit 2, the electronic switches 11 and 12 are turned on and the electronic switches 13 to 16 are turned off. At this point, the current flows into the third coil 33 via the third input end 332 and flows out of the first coil 31 via the first input end 312, with the current flowing out of the first coil 31 defined as a negative current and the current flowing into the third coil 33 defined as a positive current. Note during the time interval S1, no current flows through the second coil 32. Based on this, the current waveforms on the coils 31, 32 and 33 during the time interval S1 are obtained, as shown in FIG. 4.

Similarly, during the operation of the time interval S2, as controlled by the control unit 2, the electronic switches 12 and 13 are turned on and the electronic switches 11, 14, 15 and 16 are turned off. At this point, the current flows into the second coil 32 via the second input end 322 and flows out of the first coil 31 via the first input end 312, with the current flowing out of the first coil 31 defined as a negative current and the current flowing into the second coil 32 defined as a positive current. Note during the time interval S2, no current flows through the third coil 33. Based on this, the current waveforms on the coils 31, 32 and 33 during the time interval S2 are obtained, as shown in FIG. 4.

Similarly, only the electronic switches 13 and 14 are turned on during the time interval S3, only the electronic switches 14 and 15 are turned on during the time interval S4, only the electronic switches 15 and 16 are turned on during the time interval S5, and only the electronic switches 16 and 11 are turned on during the time interval S6.

Based on this, when the power supply Vcc is normally supplied to the fan system, the control unit 2 may generate the forward rotation command using the forward sequence of the time intervals S1 to S6, and controls the switching operation of the electronic switches 11 to 16 during each time interval of the forward rotation command. As a result, the motor 3 is operated based on the time intervals S1, S2, S3, S4, S5 and S6 in order, allowing the motor 3 to rotate in the predetermined direction.

Alternatively, when an abnormality of the power supply Vcc (such as a shutdown of the power supply Vcc) has occurred, the control unit 2 generates the backward rotation command through the backward sequence of the time intervals S1 to S6. Specifically, if the shutdown of the power supply Vcc occurs at the time interval S1, the motor 3 is operated based on the backward sequence of the time intervals S1 to S6 (e.g. S6, S5, S4, S3, S2, S1, S6 . . . ), allowing the motor 3 to rotate in a direction opposite to the predetermined direction. As a result, the motor 3 of the fan system is quickly stopped.

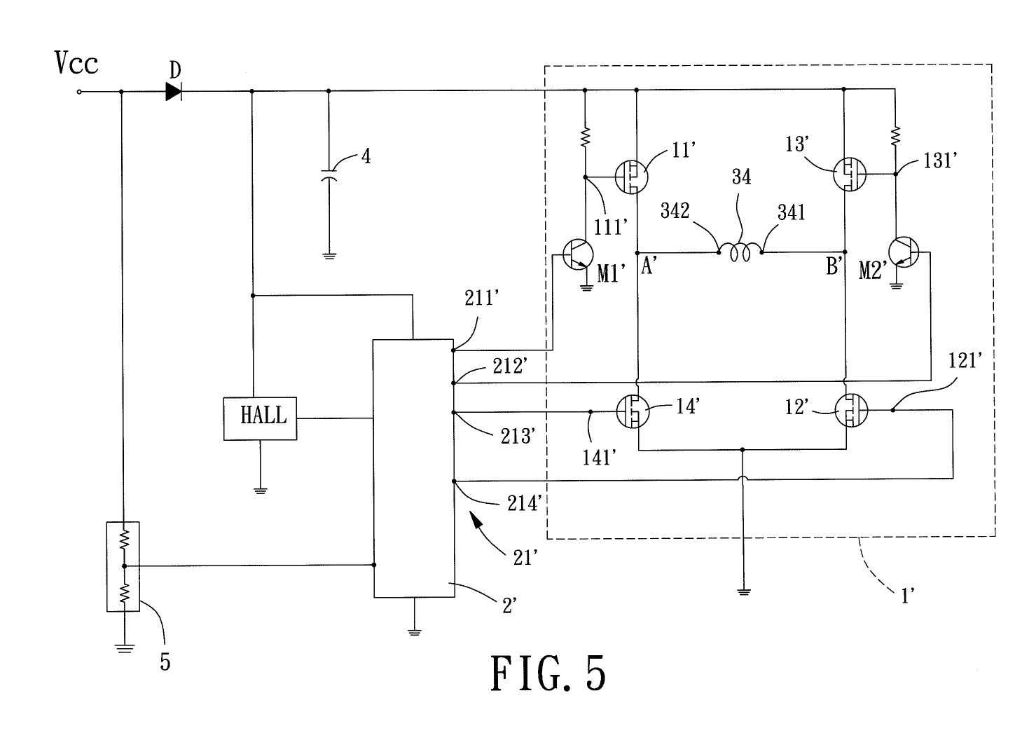

Please refer to FIGS. 2 and 5, the motor 3 of the preferred embodiment of the invention is disclosed as a single-phase motor. To comply with the phase number of the motor 3, two bridge-arms are arranged in the motor driving circuit F. The first bridge-arm consists of two series electronic switches 11′ and 14′ and has a first connection node A′. The second bridge-arm consists of two series electronic switches 13′ and 12′ and has a second connection node B′. The electronic switches 11′ to 14′ are implemented by MOS transistors and have four input ends respectively numbered as 111′, 121′, 131′ and 141′. Each of the input ends 111′ to 141′ may receive the forward/backward rotation control signal so that the corresponding electronic switch is turned-on or turned-off. The input ends 111′ and 131′ of the upper bridge electronic switches 11′ and 13′ are connected to the transistor switches M1′ and M2′, respectively. With the transistor switches M1′ and M2′, the operation of the upper bridge electronic switches 11′ and 13′ may be controlled.

Please refer to FIGS. 2 and 5 again, to comply with the phase number of the motor 3, a control port 21′ may comprise four control ends 211′, 212′, 213′ and 214′ connected to the electronic switches 11′ to 14′, respectively. The control unit 2 may generate the forward/backward rotation control signal sent to the electronic switches 11′ to 14′ via the control ends 211′ to 214′ for controlling the switching operation of the electronic switches 11′ to 14′.

Please refer to FIGS. 2 and 5 again, the proposed single-phase motor 3 comprises a single coil 34 having an output end 341 and an input end 342. The input end 342 of the coil 34 is connected to the first connection node A′ of the first bridge-arm and the output end 341 of the coil 34 is connected to the second connection node B′ of the second bridge-arm.

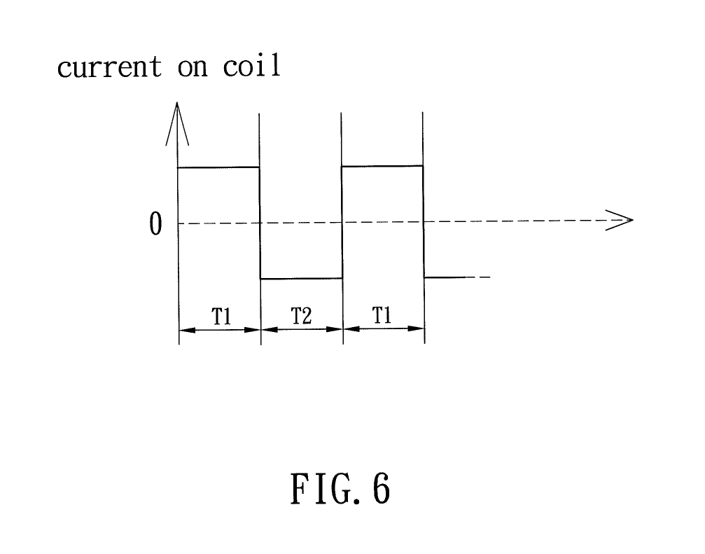

In addition, the proposed single-phase motor 3 may be controlled based on the time intervals T1 and T2 shown in FIG. 6. During the time interval T1, as controlled by the control unit 2′, the electronic switches 11′ and 12′ are turned on and the electronic switches 13′ and 14′ are turned off. As a result, the current may flow into the coil 34 via the input end 342 and is defined as a positive current. Based on this, the current waveform of the coil 34 during the time interval T1 is obtained, as shown in FIG. 6.

Similarly, during the time interval T2, as controlled by the control unit 2′, only the electronic switches 13′ and 14′ are turned on. As a result, the current may flow into the coil 34 via the output end 341 and is defined as a negative current. Based on this, the current waveform of the coil 34 during the time interval T2 is obtained, as shown in FIG. 6.

Therefore, when the power supply Vcc is normally supplied to the fan system, the control unit 2′ may generate the forward rotation command using the forward sequence of the time intervals T1 and T2 and further controls the motor 3 to rotate in the predetermined direction. In another case, when an abnormality of the power supply Vcc has occurred, the control unit 2′ may generate the backward rotation command using the backward sequence of the time intervals T1 and T2. That is, if the shutdown of the power supply Vcc occurs at the time interval T1, the motor 3 is operated based on the backward sequence of the time intervals T1 and T2 (i.e. T2, T1, T2, T1 . . . ), allowing the motor 3 to rotate in a direction opposite to the predetermined direction. As a result, the motor 3 of the fan system is quickly stopped.

Furthermore, a modification of the motor driving circuits 1 and 1′ and the control units 2 and 2′ may be applied to a double-phase motor, with the double-phase motor operated based on the forward/backward rotation command. In this way, the fast braking of the motor 3 may be achieved once an abnormality of the power supply Vcc has occurred.

In summary, when an abnormality of the power supply Vcc has occurred, the control units 2 and 2′ of the invention perform the braking operation of the fan system by controlling the motor 3 to rotate in a direction opposite to the predetermined direction. In contrast to the traditional fan system and the braking circuit thereof, the invention has achieved advantages such as lowering cost and simplifying circuitry routing due to the absence of the immediate stopping unit 94.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A fan system, comprising:
a motor;
a motor driving circuit coupled to the motor; and
a control unit coupled to the motor driving circuit, generating a forward rotation command for controlling the motor to rotate in a predetermined direction when the control unit receives electrical power, and generating a backward rotation command for controlling the motor to rotate in a direction opposite to the predetermined direction when the control unit fails to receive the electrical power.

2. The fan system as claimed in claim 1, wherein the forward rotation command is a periodic signal having a plurality of time intervals, the forward rotation command consists of a forward sequence of the time intervals and the backward rotation command consists of a backward sequence of the time intervals.

3. The fan system as claimed in claim 1, further comprising a voltage conversion unit, wherein a voltage detection end of the control unit is coupled to an anode of a diode via the voltage conversion unit for receiving the electrical power.

4. The fan system as claimed in claim 1, further comprising a storage unit, wherein the storage unit, the motor driving circuit and the control unit are coupled to a cathode of a diode.

5. The fan system as claimed in claim 1, wherein the motor driving circuit is implemented by a plurality of electronic switches, and the motor driving circuit is coupled to the motor to form a full-bridge or half-bridge structure.

6. The fan system as claimed in claim 3, wherein the voltage conversion unit comprises a voltage-dividing network.

7. The fan system as claimed in claim 1, wherein the control unit comprises a micro controller unit (MCU) or motor driving integrated circuit (IC).

8. A braking circuit of a fan system, comprising:
a control unit generating a forward rotation command for controlling a motor to rotate in a predetermined direction when the control unit receives electrical power, and generating a backward rotation command for controlling the motor to rotate in a direction opposite to the predetermined direction when the control unit fails to receive the electrical power.

9. The braking circuit of the fan system as claimed in claim 8, wherein the forward rotation command is a periodic signal having a plurality of time intervals, the forward rotation command consists of a forward sequence of the time intervals and the backward rotation command consists of a backward sequence of the time intervals.

10. The braking circuit of the fan system as claimed in claim 8, further comprising a voltage conversion unit, wherein a voltage detection end of the control unit is coupled to an anode of a diode via the voltage conversion unit for receiving the electrical power.

11. The braking circuit of the fan system as claimed in claim 8, further comprising a storage unit, wherein the storage unit and the control unit are coupled to a cathode of a diode.

12. The braking circuit of the fan system as claimed in claim 8, further comprising a motor driving circuit implemented by a plurality of electronic switches, and the motor driving circuit is coupled to the motor to form a full-bridge or half-bridge structure.

13. The braking circuit of the fan system as claimed in claim 10, wherein the voltage conversion unit comprises a voltage-dividing network.

14. The braking circuit of the fan system as claimed in claim 8, wherein the control unit comprises a micro controller unit (MCU) or motor driving integrated circuit (IC).
